(19) United States
(12) Patent Application Publication
(10) Pub. No.: US 2021/0367245 A1
(43) Pub. Date: Nov. 25, 2021

(54) FUEL CELL SYSTEM AND METHOD FOR CONTROLLING FUEL CELL

(71) Applicant: TOYOTA JIDOSHA KABUSHIKI KAISHA, Toyota-shi (JP)

(72) Inventors: Yusuke NISHIDA, Nisshin-shi (JP); Tomotaka ISHIKAWA, Nagoya-shi (JP); Masashi TOIDA, Nagoya-shi (JP)

(21) Appl. No.: 17/206,580

(22) Filed: Mar. 19, 2021

(30) Foreign Application Priority Data
May 19, 2020 (JP) 2020-087342

(51) Int. Cl. H01M 8/04089; H01M 8/04746

(52) U.S. Cl. CPC H01M 8/04089; H01M 8/04753

(57) ABSTRACT

A fuel cell system 1 is provided with a fuel cell 10 including a hydrogen passage 10h, a hydrogen supply path 31 connected to an inlet of a hydrogen passage, an injector 44 arranged in the hydrogen supply path, an anode off gas passage AP connected to an outlet of the hydrogen passage, and a drain control valve 46 provided in the anode off gas passage. Hydrogen replacement is performed in which the injector is opened so that a pressure inside the hydrogen passage becomes a required hydrogen pressure while the drain control valve is opened. The fuel cell system 1 is further provided with a pressure sensor 94a detecting the pressure inside the hydrogen passage. Hydrogen replacement is not performed when it is judged that the pressure inside the hydrogen passage is higher than the required hydrogen pressure.

### FIELD

The present disclosure relates to a fuel cell system and a method for controlling a fuel cell.

### BACKGROUND

A fuel cell system is known in the art, which is comprised of a fuel cell including a hydrogen passage, a hydrogen supply path connected to an inlet of the hydrogen passage, an injector arranged in the hydrogen supply path, an anode off gas passage connected to an outlet of the hydrogen passage, and a drain control valve provided in the anode off gas passage, which fuel cell system performs hydrogen replacement in which the injector is opened while the drain control valve is opened (for example, see PTL 1). If the amount of the nonhydrogen gases, such as nitrogen or the water vapor, etc., or liquid water, present inside of the hydrogen passage becomes greater, sufficient hydrogen may not be supplied to the fuel cell and the electric power generation efficiency of the fuel cell may fall. If hydrogen replacement is performed, the nonhydrogen gases etc. inside the hydrogen passage are replaced with hydrogen and therefore good electric power generation of the fuel cell is secured.

### CITATIONS LIST

### Patent Literature

[PTL 1] Japanese Unexamined Patent Publication No. 2009-170199

### SUMMARY

### Technical Problem

In this regard, if hydrogen replacement is performed, not only nonhydrogen gases, but also hydrogen are discharged from the drain control valve. For this reason, if hydrogen replacement is performed when the pressure inside the hydrogen passage is high, high concentration hydrogen may be discharged from the drain control valve.

### Solution to Problem

According to the present disclosure, the following are provided:

### [Constitution 1]

A fuel cell system comprising:
a fuel cell including a hydrogen passage;
a hydrogen supply path connected to an inlet of the hydrogen passage;
an injector arranged in the hydrogen supply path;
an anode off gas passage connected to an outlet of the hydrogen passage;
a drain control valve provided in the anode off gas passage;
a replacement control part configured to perform hydrogen replacement in which the injector is opened so that a pressure inside the hydrogen passage becomes a required hydrogen pressure while the drain control valve is opened; and
a pressure sensor configured to detect the pressure inside the hydrogen passage,

wherein the replacement control part is further configured not to perform hydrogen replacement when it is judged that the pressure inside the hydrogen passage is higher than the required hydrogen pressure.

### [Constitution 2]

The fuel cell system according to Constitution 1, further comprising an atmospheric pressure sensor configured to detect atmospheric pressure,

wherein the replacement control part is further configured to set the required hydrogen pressure to a value higher than the atmospheric pressure detected by the atmospheric pressure sensor by a preset value.

### [Constitution 3]

A fuel cell system comprising:
a fuel cell including a hydrogen passage;
a hydrogen supply path connected to an inlet of the hydrogen passage;
an injector arranged in the hydrogen supply path;
an anode off gas passage connected to an outlet of the hydrogen passage;
a drain control valve provided in the anode off gas passage;
a replacement control part configured to perform hydrogen replacement in which the injector is opened so that a pressure inside the hydrogen passage becomes a required hydrogen pressure while the drain control valve is opened; and
an atmospheric pressure sensor configured to detect atmospheric pressure,

wherein the replacement control part is further configured to set the required hydrogen pressure to a value higher than the atmospheric pressure by a preset value.

### [Constitution 4]

The fuel cell system according to Constitution 3, further comprising a compressor configured to supply air to the anode off gas passage,

wherein the replacement control part is further configured to:
operate the compressor at the time of hydrogen replacement and
set the required hydrogen pressure so as not to fall below a predetermined, lower limit pressure.

### [Constitution 5]

The fuel cell system according to Constitution 4, wherein the replacement control part is further configured to set the amount of air supplied from the compressor to the anode off gas passage based on a difference of the required hydrogen pressure with respect to the atmospheric pressure.

### [Constitution 6]

The fuel cell system according to Constitution 5, wherein the replacement control part is further configured not to perform hydrogen replacement when it is judged that the amount of air supplied from the compressor to the anode off gas passage is smaller than a target amount.

### [Constitution 7]

A method of controlling a fuel cell system, which fuel cell system comprising:
a fuel cell including a hydrogen passage;
a hydrogen supply path connected to an inlet of the hydrogen passage; an injector arranged in the hydrogen supply path;
an anode off gas passage connected to an outlet of the hydrogen passage;
a drain control valve provided in the anode off gas passage; and
a pressure sensor configured to detect the pressure inside the hydrogen passage, the method including:
performing hydrogen replacement in which the injector is opened so that a pressure inside the hydrogen passage becomes a required hydrogen pressure while the drain control valve is opened when it is judged that the pressure inside the hydrogen passage is lower than the required hydrogen pressure; and
not performing hydrogen replacement when it is judged that the pressure inside the hydrogen passage is higher than the required hydrogen pressure.

### [Constitution 8]

A method of controlling a fuel cell system, which fuel cell system comprising:
a fuel cell including a hydrogen passage;
a hydrogen supply path connected to an inlet of the hydrogen passage;
an injector arranged in the hydrogen supply path;
an anode off gas passage connected to an outlet of the hydrogen passage;
a drain control valve provided in the anode off gas passage; and
an atmospheric pressure sensor configured to detect atmospheric pressure, the method including:
performing hydrogen replacement in which the injector is opened so that a pressure inside the hydrogen passage becomes a required hydrogen pressure while the drain control valve is opened, and
setting the required hydrogen pressure to a value higher than the atmospheric pressure detected by the atmospheric pressure sensor by a preset value.

### Advantageous Effects of Invention

It is possible to limit high concentration hydrogen from being discharged through the drain control valve.

### BRIEF DESCRIPTION OF DRAWINGS

FIG. 1 is a schematic overall view of a fuel cell system of an embodiment according to the present disclosure.

FIG. 2 is a graph showing a required hydrogen pressure of an embodiment according to the present disclosure.

FIG. 3 is a flow chart showing a startup control routine of an embodiment according to the present disclosure.

FIG. 4 is a flow chart showing a hydrogen replacement control routine of an embodiment according to the present disclosure.

FIG. 5 is a functional block diagram of an electronic control unit from one aspect of an embodiment according to the present disclosure.

FIG. 6 is a functional block diagram of an electronic control unit from another aspect of an embodiment according to the present disclosure.

### DESCRIPTION OF EMBODIMENTS

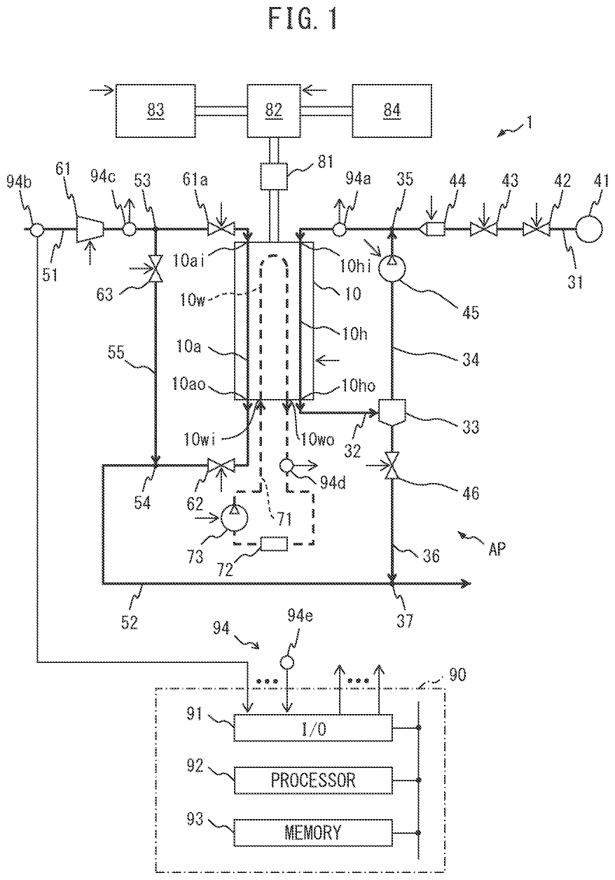

Referring to FIG. 1, in an embodiment according to the present disclosure, a fuel cell system 1 is provided with a fuel cell 10. The fuel cell 10 is formed by a plurality of unit cells stacked together. The fuel cell 10 is provided with a hydrogen passage 10h, air passage 10a, and cooling water passage 10w. In one example, the fuel cell system 1 is mounted in a vehicle.

In an embodiment according to the present disclosure, the hydrogen passage 10h extends inside the fuel cell 10 from an inlet 10hi to an outlet 10ho. At the inlet 10hi, a hydrogen supply path 31 is connected. At the outlet 10ho, a hydrogen exhaust path 32 is connected. The outlet of the hydrogen exhaust path 32 is connected to an inlet of a gas-liquid separator 33. A top outlet of the gas-liquid separator 33 is connected through a return passage 34 to a merging point 35 of the hydrogen supply path 31. A bottom outlet of the gas-liquid separator 33 is connected through a drain passage 36 to a merging point 37 of an air exhaust path 52 (later explained). In an embodiment according to the present disclosure, the hydrogen exhaust path 32, gas-liquid separator 33, drain passage 36, and air exhaust path 52 downstream of the merging point 37 will also be referred to as an “anode off gas passage AP”.

In an embodiment according to the present disclosure, the inlet of the hydrogen supply path 31 is connected to a hydrogen tank 41. Further, in the hydrogen supply path 31, in order from the upstream side, a main check valve 42 of a solenoid type, a regulator 43 of a solenoid type, and an injector 44 of a solenoid type are provided. The above-mentioned merging point 35 is positioned downstream of the injector 44 in the hydrogen supply path 31. Further, in the return passage 34, a return pump 45 for returning hydrogen to the hydrogen supply path 31 is provided. Furthermore, in the drain passage 36, a drain control valve 37 of a solenoid type is arranged.

Further, in an embodiment according to the present disclosure, the air passage 10a extends through the inside of the fuel cell 10 from an inlet 10ai to an outlet 10ao. At the inlet 10ai, an air supply path 51 is connected. At the outlet 10ao, an air exhaust path 52 is connected. A diverging point 53 of the air supply path 51 and a merging point 54 of the air exhaust path 52 are connected with each other by a bypass passage 55 bypassing the fuel cell 10.

In an embodiment according to the present disclosure, the inlet of the air passage 10a is communicated with the atmosphere. Further, in the air supply path 51, a compressor 61 is arranged. The above-mentioned diverging point 53 is positioned downstream of the compressor 61 in the air supply path 51. Downstream of the diverging point 53 in the air supply path 51, an inlet valve 61a of a solenoid type is provided. Further, in the air exhaust path 52, a pressure regulating valve 62 of a solenoid type is provided. Further, in the bypass passage 55, a bypass control valve 63 of a solenoid type is provided.

Inside of the hydrogen passage 10h, an anode (not shown) is arranged. Further, inside of the air passage 10a, a cathode (not shown) is arranged. Furthermore, between the anode and the cathode, a membrane-like electrolyte (not shown) is arranged.

When normal operation is to be performed, the main check valve 42, regulator 43, and injector 44 are opened and hydrogen is supplied to the fuel cell 10. On the other hand, the compressor 61 is actuated, the inlet valve 61a and pressure regulating valve 62 are opened, and air or oxygen is supplied to the fuel cell 10. As a result, in the fuel cell 10, an electrochemical reaction (H₂→2H⁺+2e⁻, (½)O₂+2H⁺+2e⁻→H₂O) occurs and electric power is generated. This electric power is sent from the fuel cell 10 to the motor-generator 83, battery 84, etc.

An anode off gas, that is exhausted from the hydrogen passage 10h at this time, is sent through the hydrogen exhaust path 32 to the gas-liquid separator 33. In the anode off gas, unreacted hydrogen, the water generated inside the fuel cell 10, nitrogen and oxygen etc. passing from the air passage 10a through the electrolytic membrane are included. At the gas-liquid separator 33, the anode off gas is separated into a gas component and a liquid component. The gas component of the anode off gas including the hydrogen is returned by the return pump 45 through the return passage 34 to the hydrogen supply path 31 (circulation operation). On the other hand, a cathode off gas exhausted from the air passage 10a is discharged through the air exhaust path 52 into the atmosphere.

On the other hand, the drain control valve 46 of an embodiment according to the present disclosure is normally closed. If the drain control valve 46 is opened, the liquid component of the anode off gas is discharged through the drain passage 36 to the air exhaust path 52.

Furthermore, referring to FIG. 1, in an embodiment according to the present disclosure, the cooling water passage 10w extends through the inside of the fuel cell 10 from an inlet 10wi to an outlet 10wo. The inlet 10wi and the outlet 10wo are connected to each other outside of the fuel cell 10 by a cooling water circulation passage 71. Inside the cooling water circulation passage 71, in order from the upstream side, a radiator 72 and a cooling water pump 73 are provided.

Furthermore, referring to FIG. 1, in an embodiment according to the present disclosure, the fuel cell 10 is electrically connected through a boost converter 81 to a power control unit 82. The power control unit 82 is electrically connected for example to a motor-generator 83 and a battery 84. The electric power generated at the fuel cell 10 is sent by the power control unit 82 to the motor-generator 83 operating as an electric motor to generate vehicle drive power, or is sent to and stored in the battery 84. At this time, the output voltage of the fuel cell 10 is raised by the boost converter 81 to the boost voltage. In an embodiment according to the present disclosure, the boost voltage of the boost converter 81 can be changed by the power control unit 82. At the time of normal operation, the boost voltage is maintained at a base boost voltage VBB. Note that, when the motor-generator 83 is operated as an electric generator by regenerative processing, the electric power generated at the motor-generator 83 is sent through the power control unit 82 to the battery 84.

The fuel cell system 1 of an embodiment according to the present disclosure is provided with an electronic control unit 90. The electronic control unit 90 for example includes an input-output port 91, one or more processors 92, and one or more memories 93, communicatively connected with each other, via a bidirectional bus. The processors 92 include microprocessors (CPUs) etc. The memories 93 for example include ROMs (read only memories), RAMs (random access memories), etc. In the memories 93, various programs are stored. These programs are executed at the processors 92 whereby various routines are executed.

One or more sensors 94 are communicatively connected to the input-output port 91. The sensors 94 include, for example, a pressure sensor 94a provided between the merging point 35 and the fuel cell 10 for detecting the pressure inside the hydrogen passage 10h, an air flow meter 94b provided upstream of the compressor 61 in the air supply path 51 for detecting the quantity of air circulating through the air supply path 51, a pressure sensor 94c provided between the compressor 61 and the diverging point 53 in the air supply path 51 for detecting the pressure inside the air passage 10a, a water temperature sensor 94d attached to the cooling water circulation path 71 for detecting the temperature of the cooling water flowing out from the cooling water passage 10w, an atmospheric pressure sensor 94e for detecting the atmospheric pressure, etc. The quantity of air detected by the air flow meter 94b expresses the quantity of air supplied from the compressor 61. The pressure detected by the pressure sensor 94c expresses the pressure inside the hydrogen passage 10h. The temperature detected by the water temperature sensor 94d expresses the temperature of the fuel cell 10 or the fuel cell system 1. At the processors 92, the amount of electric power sent into the battery 84 and the amount of electric power sent out from the battery 84 are repeatedly added up whereby the state of charge (SOC) of the battery 84 is calculated. On the other hand, the input-output port 91 is communicatively connected to the fuel cell 10, main check valve 42, regulator 43, injector 44, return pump 45, drain control valve 46, compressor 61, inlet valve 61a, pressure regulating valve 62, bypass control valve 63, cooling water pump 73, power control unit 82, motor-generator 83, etc. These fuel cell 10 etc. are controlled based on signals from the electronic control unit 90. Note that, the main check valve 42, regulator 43, injector 44, drain control valve 46, inlet valve 61a, pressure regulating valve 62, bypass control valve 63, cooling water pump 73, compressor 61, electronic control unit 90, etc. operate by electric power from the battery 84 until at least electric power generation is started at the fuel cell 10.

Now then, in an embodiment according to the present disclosure, at the time of startup of the fuel cell system 1, hydrogen replacement is performed wherein the injector 44 is opened while the drain control valve 46 is opened. Explained schematically, due to hydrogen replacement, the nonhydrogen gases inside the hydrogen supply path 31 downstream of the injector 44, hydrogen passage 10h, hydrogen exhaust path 32, gas-liquid separator 33, and drain passage 36 upstream of the drain control valve 46 etc. are pushed out and replaced by hydrogen from the injector 44. Therefore, good electric power generation at the fuel cell 10 is secured. Note that, at the time of hydrogen replacement, the return pump 45 is stopped.

If hydrogen replacement is performed, the nonhydrogen gases flow out through the drain control valve 46 to the inside of the air exhaust path 52, then are discharged into the atmosphere. On the other hand, at the time of hydrogen replacement of an embodiment according to the present disclosure, the compressor 61 is actuated. The air from the compressor 61 circulates through the air passage 10a or the bypass passage 55 through the air exhaust path 52. The gases discharged from the drain control valve 46 at the time of hydrogen replacement include hydrogen as well. The air from the compressor 61 is used for diluting this hydrogen.

In the hydrogen replacement of an embodiment according to the present disclosure, hydrogen is supplied from the injector 44 so that the pressure inside of the hydrogen passage 10h, that is, the hydrogen pressure PH, becomes the required hydrogen pressure PHR. In one example, the injector 44 is controlled so that the hydrogen pressure PH does not fall below the required hydrogen pressure PHR.

In this regard, however, if hydrogen replacement is performed when the pressure PH inside the hydrogen passage 10h is high, high concentration hydrogen may be discharged from the drain control valve 46 and the hydrogen may be unable to be sufficiently diluted.

Therefore, in an embodiment according to the present disclosure, when it is judged that the hydrogen pressure PH when hydrogen replacement should be started is lower than the required hydrogen pressure PHR, first hydrogen replacement is performed, then normal operation is started. As opposed to this, when it is judged that the hydrogen pressure PH is higher than the required hydrogen pressure PHR, normal operation is started without performing hydrogen replacement. In other words, hydrogen replacement is skipped. As a result, high concentration hydrogen is limited from being discharged and hydrogen is effectively utilized. Note that, it is also possible to take the view that if the hydrogen pressure PH when hydrogen replacement should be started is high, the concentration of hydrogen inside the hydrogen passage 10h is high and thus hydrogen replacement and removal of nonhydrogen gases is not required.

In an embodiment according to the present disclosure, the required hydrogen pressure PHR is set to be higher than the atmospheric pressure Patm by a preset value, such as a constant value α (PHR=Patm+α). In other words, the required hydrogen pressure PHR is set so that a difference dP (=PHR−Patm) of the required hydrogen pressure PHR with respect to the atmospheric pressure Patm becomes the constant value a. This pressure difference dP expresses the amount or flow rate of gas flowing from the drain control valve 46 to the inside of the air exhaust path 52. Therefore, in an embodiment of the present disclosure, the amount of gas discharged from the drain control valve 46 is maintained substantially constant regardless of the atmospheric pressure Patm.

On this point, if setting the required hydrogen pressure to a constant pressure (absolute pressure), the amount of gas discharged from the drain control valve 46 would unfavorably fluctuate in accordance with the atmospheric pressure. Further, if setting the required hydrogen pressure to a high constant pressure, when the atmospheric pressure is high, the discharge of gas from the drain control valve 46 could be secured, but when the atmospheric pressure is low, the amount of gas discharged from the drain control valve 46 may become excessively large. Conversely, if setting the required hydrogen pressure to a low constant pressure, when the atmospheric pressure is low, it is possible to keep a large amount of gas from being discharged from the drain control valve 46, but when the atmospheric pressure is high, gas may not be discharged from the drain control valve 46. In an embodiment according to the present disclosure, such a problem does not arise.

In this regard, however, in the case where the required hydrogen pressure PHR is calculated by addition of the constant valuea to the atmospheric pressure Patm, if the atmospheric pressure Patm becomes lower, the required hydrogen pressure PHR will also become lower. In this regard, however, as explained above, air from the compressor 61 is circulating in the air exhaust path 52 and the pressure inside the air exhaust path 52 is higher than the atmospheric pressure Patm. In this case, if the hydrogen pressure PH or the required hydrogen pressure PHR is lower than the pressure inside the air exhaust path 52, the air circulating through the inside of the air exhaust path 52 may flow back through the drain passage 36 and air may flow into the hydrogen passage 10h.

Therefore, in an embodiment according to the present disclosure, the required hydrogen pressure PHR is set so as not to fall under a lower limit pressure PHLL set in advance. As a result, the air circulating through the air exhaust path 52 is limited from flowing back through the drain passage 36. Note that, the lower limit pressure PHLL of an embodiment according to the present disclosure is set to a constant pressure.

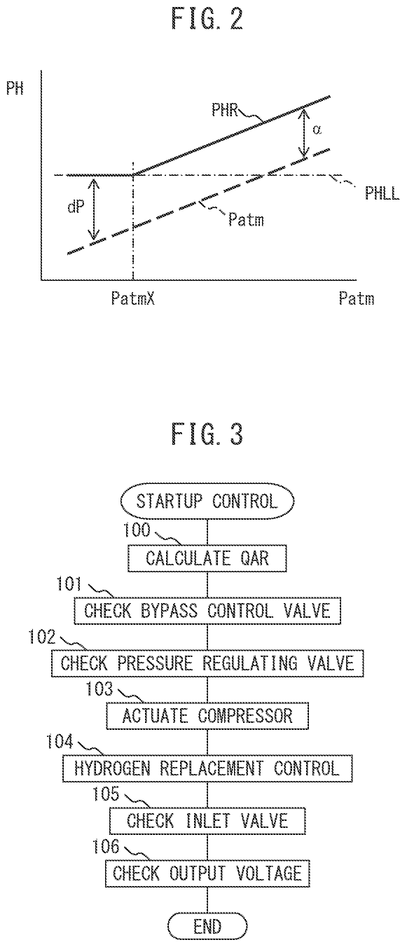

FIG. 2 shows the required hydrogen pressure PHR of an embodiment according to the present disclosure. As shown in FIG. 2, the required hydrogen pressure PHR is set to Patm+a when the atmospheric pressure Patm is higher than a threshold value PatmX and is set to the lower limit pressure PHLL when the atmospheric pressure Patm is lower than the threshold value PatmX. In another embodiment (not shown), the lower limit pressure PHLL is not set and the required hydrogen pressure PHR is set to Patm+a over the entire range of the atmospheric pressure Patm.

As shown in FIG. 2, the pressure difference dP (=PHR−Patm) of an embodiment according to the present disclosure becomes the constant value α if the atmospheric pressure Patm is higher than the threshold value PatmX and becomes larger than the constant value cc if the atmospheric pressure Patm is lower than the threshold value PatmX. For this reason, when the atmospheric pressure Patm is lower than the threshold value PatmX, the amount of gas discharged from the drain control valve 46 is larger compared with when the atmospheric pressure Patm is higher than the threshold value PatmX. In this case, according to Bernoulli distribution, the amount of gas when the atmospheric pressure Patm is lower than the threshold value PatmX becomes \sqrt{ }(dP/α) times the amount of gas when the atmospheric pressure Patm is higher than the threshold value PatmX.

On the other hand, in an embodiment according to the present disclosure, as explained above, air is supplied from the compressor 61 at the time of hydrogen replacement, and this air is used for diluting the hydrogen discharged from the drain control valve 46. The amount of air in this case must be sufficient for diluting the gas or hydrogen discharged from the drain control valve 46.

Therefore, in an embodiment according to the present disclosure, the required quantity of air QAR for hydrogen replacement is set based on the pressure difference dP, and the compressor 61 is controlled so that the quantity of air QA from the compressor 61 becomes a required quantity of air QAR. Specifically, when the atmospheric pressure Patm is higher than the threshold value PatmX and the pressure difference dP is the constant value a, the required quantity of air QAR is set to a base quantity of air QAB. As opposed to this, when the atmospheric pressure Patm is lower than the threshold value PatmX and the pressure difference dP is larger than the constant value a, the required quantity of air QAR is set to \sqrt{ }(dP/a) times the base quantity of air QAB (QAR=\sqrt{ }(dP/α)×QAB). As a result, the hydrogen is reliably diluted regardless of the pressure difference dP, that is, regardless of the amount of gas discharged from the drain control valve 46. Note that, the required hydrogen pressure PH is a function of the atmospheric pressure Patm and the pressure difference dP is also a function of the atmospheric pressure Patm, so the required quantity of air QAR for hydrogen replacement can be calculated as a function of the atmospheric pressure Patm.

In this regard, however, for example, if the compressor 61 malfunctions, the quantity of air QA from the compressor 61 may become smaller than the required quantity of air QAR. In this case, it is difficult to sufficiently dilute the hydrogen from the drain control valve 46.

Therefore, in an embodiment according to the present disclosure, when it is judged that the quantity of air QA from the compressor 61 is greater than the required quantity of air QAR, hydrogen replacement is performed, while when it is judged that the quantity of air QA from the compressor 61 is smaller than the required quantity of air QAR, hydrogen replacement is skipped or suspended. As a result, high concentration hydrogen is limited from being discharged.

Further, in an embodiment according to the present disclosure, when it is judged that a state of charge SOC of the battery 84 is higher than a required state of charge SOCR, hydrogen replacement is performed, while when it is judged that the state of charge SOC of the battery 84 is lower than the required state of charge SOCR, hydrogen replacement is skipped or suspended. Here, the required state of charge SOCR expresses the amount of electric power required for making the injector 44, drain control valve 46, compressor 61, etc. operate for hydrogen replacement. As a result, hydrogen replacement is reliably performed.

In this regard, in an embodiment according to the present disclosure, as explained above, at the time of normal operation, a circulation operation is performed where the gas component from the gas-liquid separator 33 including the hydrogen is returned by the return pump 45 to the hydrogen supply path 31. In this regard, however, when hydrogen replacement is not performed, a large amount of nonhydrogen gases may remain in the hydrogen passage 10h, hydrogen exhaust path 32, gas-liquid separator 33, etc. If a circulation operation is performed in this state, a large amount of nonhydrogen gases may be supplied to the hydrogen passage 10h and the concentration of nonhydrogen gases inside the hydrogen passage 10h may rise. In particular, at cold times, if clogging occurs due to freezing near the outlet of the hydrogen passage 10h, for example, the concentration of nonhydrogen gases inside the hydrogen passage 10h may become excessively high. In this case, in the fuel cell 10, good electric power generation is difficult to obtain.

Therefore, in an embodiment according to the present disclosure, when hydrogen replacement is not performed, the circulation operation is stopped. Specifically, the return pump 45 is stopped. As a result, the nonhydrogen gases are limited from being returned to the hydrogen passage 10h. Note that, for example, when hydrogen replacement is performed at the time of the next startup of the fuel cell system 1, a circulation operation is performed.

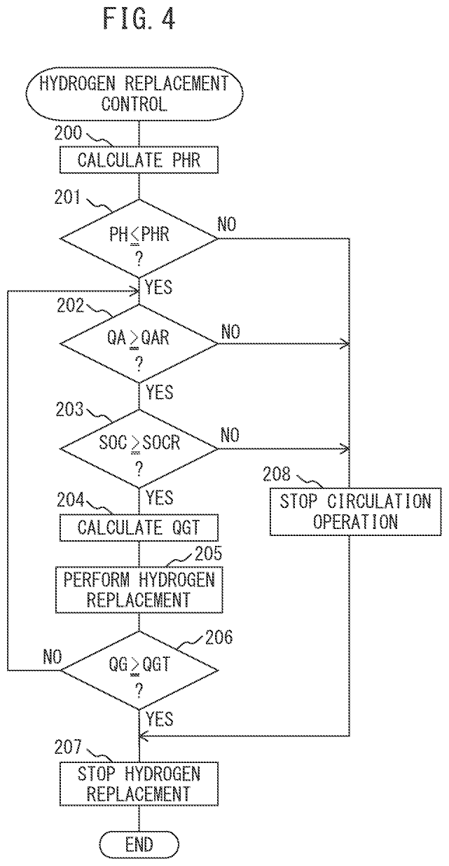

FIG. 3 shows a startup control routine performed at the time of startup of the fuel cell system 1 in an embodiment according to the present disclosure. Referring to FIG. 3, at step 100, the required quantity of air QAR for hydrogen replacement is calculated. At the next step 101, it is checked that the bypass control valve 63 is operating normally. At the next step 102, it is checked that the pressure regulating valve 62 is operating normally. At the next step 103, the compressor 61 is actuated for hydrogen replacement. At the next step 104, a hydrogen replacement control routine is performed for performing hydrogen replacement. This routine is shown in FIG. 4. At the next step 105, it is checked that the inlet valve 61a is operating normally. At the next step 106, the output voltage of the fuel cell 10 is checked. After that, normal operation of the fuel cell 10 is started.

FIG. 4 shows a hydrogen replacement control routine of an embodiment according to the present disclosure. Referring to FIG. 4, at step 200, the required hydrogen pressure QHR is calculated. At the next step 201, it is judged if the hydrogen pressure PH is the required hydrogen pressure PHR or less. When PH=<PHR, next the routine proceeds to step 202 where it is judged if the quantity of air QA from the compressor 61 is the required quantity of air QAR or more. When QA>=QAR, next the routine proceeds to step 203 where it is judged if the state of charge SOC of the battery 84 is the required state of charge SOCR or more. When SOC>=SOCR, next, the routine proceeds to step 204 where the target quantity (QGT) of the gas discharged from the drain control valve 46 in hydrogen replacement is calculated. At the next step 205, hydrogen replacement is performed. At the next step 206, it is judged if the quantity of gas QG discharged from the drain control valve 46 in hydrogen replacement is the target quantity QGT or more. When QG<QGT, the routine returns to step 202. As opposed to this, when QG>=QGT, next the routine proceeds to step 208 where hydrogen replacement is stopped.

When at step 201 PH>PHR, when at step 202 QA<QAR, or when at step 203, SOC<SOCR, next the routine proceeds to step 208 where the circulation operation is stopped. Next, the routine proceeds to step 207. Therefore, the hydrogen replacement is skipped or suspended.

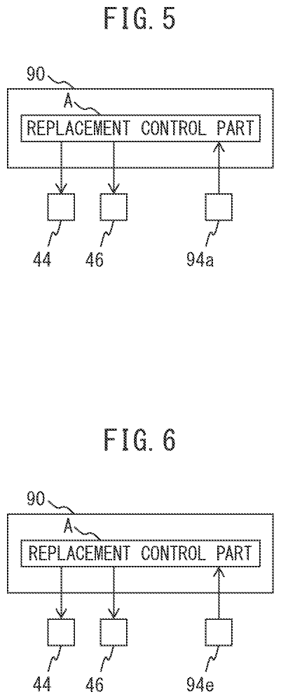

Therefore, according to one aspect of an embodiment according to the present disclosure, as shown by the functional block diagram of the electronic control unit 90 of FIG. 5, there is provided a fuel cell system 1 comprising a fuel cell 10 including a hydrogen passage 10h, a hydrogen supply path 31 connected to an inlet 10hi of the hydrogen passage 10h, an injector 44 arranged in the hydrogen supply path 31, an anode off gas passage AP connected to an outlet 10ho of the hydrogen passage 10h, a drain control valve 46 provided in the anode off gas passage AP, a replacement control part A configured to perform hydrogen replacement in which the injector 44 is opened so that a pressure PH inside the hydrogen passage 10h becomes a required hydrogen pressure PHR while the drain control valve 46 is opened, and a pressure sensor 94a configured to detect the pressure PH inside the hydrogen passage 10h, wherein, the replacement control part A is further configured not to perform hydrogen replacement when it is judged that the pressure PH inside the hydrogen passage 10h is higher than the required hydrogen pressure PHR.

Further, according to another aspect of an embodiment according to the present disclosure, as shown by the functional block diagram of the electronic control unit 90 of FIG. 6, there is provided a fuel cell system 1 comprising a fuel cell 10 including a hydrogen passage 10h, a hydrogen supply path 31 connected to an inlet 10hi of the hydrogen passage 10h, an injector 44 arranged in the hydrogen supply path 31, an anode off gas passage AP connected to an outlet 10ho of the hydrogen passage 10h, a drain control valve 46 provided in the anode off gas passage AP, a replacement control part A configured to perform hydrogen replacement in which the injector 44 is opened so that a pressure PH inside the hydrogen passage 10h becomes a required hydrogen pressure PHR while the drain control valve 46 is opened, and an atmospheric pressure sensor 94e configured to detect atmospheric pressure Patm, wherein the replacement control part A is further configured to set the required hydrogen pressure PHR to a value higher than the atmospheric pressure Patm by a preset value a.

This application claims the benefit of Japanese Patent Application No. 2020-087342, the entire disclosure of which is incorporated by reference herein.

### REFERENCE SIGNS LIST

1. fuel cell system

10. fuel cell

10h. hydrogen passage

31. hydrogen supply path

44. injector

46. drain control valve

90. electronic control unit

94a. pressure sensor

94e. atmospheric pressure sensor

AP. anode off gas passage

A. replacement control part

1. A fuel cell system comprising:
a fuel cell including a hydrogen passage;
a hydrogen supply path connected to an inlet of the hydrogen passage;
an injector arranged in the hydrogen supply path;
an anode off gas passage connected to an outlet of the hydrogen passage;
a drain control valve provided in the anode off gas passage;
a replacement control part configured to perform hydrogen replacement in which the injector is opened so that a pressure inside the hydrogen passage becomes a required hydrogen pressure while the drain control valve is opened; and
a pressure sensor configured to detect the pressure inside the hydrogen passage,
wherein the replacement control part is further configured not to perform hydrogen replacement when it is judged that the pressure inside the hydrogen passage is higher than the required hydrogen pressure.

2. The fuel cell system according to claim 1, further comprising an atmospheric pressure sensor configured to detect atmospheric pressure,
wherein the replacement control part is further configured to set the required hydrogen pressure to a value higher than the atmospheric pressure detected by the atmospheric pressure sensor by a preset value.

3. A fuel cell system comprising:
a fuel cell including a hydrogen passage;
a hydrogen supply path connected to an inlet of the hydrogen passage;
an injector arranged in the hydrogen supply path;
an anode off gas passage connected to an outlet of the hydrogen passage;
a drain control valve provided in the anode off gas passage;
a replacement control part configured to perform hydrogen replacement in which the injector is opened so that a pressure inside the hydrogen passage becomes a required hydrogen pressure while the drain control valve is opened; and
an atmospheric pressure sensor configured to detect atmospheric pressure,
wherein the replacement control part is further configured to set the required hydrogen pressure to a value higher than the atmospheric pressure by a preset value.

4. The fuel cell system according to claim 3, further comprising a compressor configured to supply air to the anode off gas passage,
wherein the replacement control part is further configured to:
operate the compressor at the time of hydrogen replacement and
set the required hydrogen pressure so as not to fall below a predetermined, lower limit pressure.

5. The fuel cell system according to claim 4, wherein the replacement control part is further configured to set the amount of air supplied from the compressor to the anode off gas passage based on a difference of the required hydrogen pressure with respect to the atmospheric pressure.

6. The fuel cell system according to claim 5, wherein the replacement control part is further configured not to perform hydrogen replacement when it is judged that the amount of air supplied from the compressor to the anode off gas passage is smaller than a target amount.

7. A method of controlling a fuel cell system, which fuel cell system comprising:
a fuel cell including a hydrogen passage;
a hydrogen supply path connected to an inlet of the hydrogen passage;
an injector arranged in the hydrogen supply path;
an anode off gas passage connected to an outlet of the hydrogen passage;
a drain control valve provided in the anode off gas passage; and
a pressure sensor configured to detect the pressure inside the hydrogen passage, the method including:
performing hydrogen replacement in which the injector is opened so that a pressure inside the hydrogen passage becomes a required hydrogen pressure while the drain control valve is opened when it is judged that the pressure inside the hydrogen passage is lower than the required hydrogen pressure; and
not performing hydrogen replacement when it is judged that the pressure inside the hydrogen passage is higher than the required hydrogen pressure.

8. A method of controlling a fuel cell system, which fuel cell system comprising:
a fuel cell including a hydrogen passage;
a hydrogen supply path connected to an inlet of the hydrogen passage;
an injector arranged in the hydrogen supply path;
an anode off gas passage connected to an outlet of the hydrogen passage;
a drain control valve provided in the anode off gas passage; and
an atmospheric pressure sensor configured to detect atmospheric pressure, the method including:
performing hydrogen replacement in which the injector is opened so that a pressure inside the hydrogen passage becomes a required hydrogen pressure while the drain control valve is opened, and
setting the required hydrogen pressure to a value higher than the atmospheric pressure detected by the atmospheric pressure sensor by a preset value.
